(19) United States
(12) Patent Application Publication
(10) Pub. No.: US 2006/0186273 A1
(43) Pub. Date: Aug. 24, 2006

(54) Tube kite

(76) Inventors: Till Eberle, Oberhaching (DE); William Kenneth Winner, Hood River, OR (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/360,942

(22) Filed: Feb. 23, 2006

(30) Foreign Application Priority Data
Feb. 23, 2005 (DE) 102005008606.3
Mar. 30, 2005 (DE) 102005014848.4
Nov. 23, 2005 (DE) 202005018317.2

(51) Int. Cl. B64D 17/34

(52) U.S. Cl. 244/152

(57) ABSTRACT

A tube kite where support members, e.g., sail battens, are formed in the range of attack in order to increase the angle of attack in comparison with conventional solutions, so that it is possible to reduce the diameter of a front tube and thus reduce air flow resistance without substantially compromising flight stability.

### BACKGROUND OF THE INVENTION

1. Field of the Invention

The invention concerns a tube kite and more particularly, a tube kite with a front tube having a reduced diameter to reduce air flow resistance without compromising flight stability.

2. Description of Related Art

A tube kite is disclosed, e.g., in DE 203 20 389 and includes a tube arrangement carrying a canopy. The inflatable tube arrangement consists substantially of a front tube on which inflatable ribs or struts (transverse struts) supporting the sail profile and extending in the direction of attack are formed. In the known solution, one front line and one back line each are attached to the two tips of the kite. In the central range of the front tube, a supplementary line (so-called 5^{th} line) is attached which allows the surfer to stabilize the profile of the kite in the flight phase. Such a kite is distributed under the product name “RHINO 05” and has demonstrated its superiority in comparison with conventional solutions without a supplementary line.

The company Windtools is, or was, distributing a kite under the product name “Booster,” in which the sail profile is not supported by inflatable transverse struts but by sail battens that extend across the entire profile width so that the trailing edge is inclined relative to the leading edge. With regard to function, these sail battens do not differ from the inflatable transverse struts, however they facilitate assembly, for inflating the transverse struts may be omitted.

It is moreover known to provide sail battens at the two tips of the kite for the purpose of stabilization.

In order to reduce the air flow resistance of the kite, it is desirable to make the diameter of the front tube as small as possible. It was, however, found in flying tests that the kites designed with a front tube reduced in their cross-section do not exhibit the required flight stability at particular wind conditions, and therefore have a critical flying behavior.

### SUMMARY OF THE INVENTION

The preferred embodiment, in contrast to known tube kites, is based on the object of furnishing a tube kite having good flight stability even at a small front tube diameter.

This object is achieved through a tube kite having a sail, wherein a front tube, transverse ribs and a canopy inclined relative thereto form a profile, and wherein on the front tube, between tips of the kite, support members supporting the sail are attached, whereby the sail is inclined relative to the front tube so as to increase an angle of attack, and which extend substantially only along a portion of the profile.

In accordance with the invention, the tube kite has a multiplicity of support members arranged in the range between its tips, whereby the canopy may be inclined relative to the front tube, so that the angle of attack of the kite is increased and maintained stable in comparison with solutions lacking these support members. This increased angle of attack allows to execute the front tube with a smaller cross-section in the absence of a negative impact on the flight stability. This advantage particularly makes itself felt in kites having a supplementary line (fifth element). Thanks to the improved configuration of the “kite” to thus have a full, rounded air flow profile, the performance of the kite may be improved substantially. At a large inclination angle of the kite, burble is prevented, while at small inclination angles the profile is stabilized and prevents being flattened out by the flow impacting on the leading edge, to thus lose efficiency.

Thanks to the support members in accordance with the invention, the profile is thus purposely stabilized in the range of attack, and the angle of attack is increased in comparison with kites lacking such support members.

In the prior art “Booster” as described at the outset, the sail battens essentially serve as a substitute for the transverse struts—the effect in accordance with the invention including the increase of the angle of attack may not be obtained with these continuous sail battens that extend across the entire profile.

In accordance with an advantageous development of the invention, the support members have the form of sail battens, the length and rigidity of which are chosen with a view to an optimum configuration of the air flow profile. The sail battens extend, other than in the prior art, only across a partial range of the kite profile.

Fixation of the support members is preferably performed at receptions or pockets of an outer skin of the front tube. In order to enhance the supporting effect of these support members/sail battens, these receptions may extend beyond the range of fixation of the sail at the front tube, so that the support members are reliably supported on the transverse tube.

A support is achieved in such a manner that the support members extend without a sail about tangentially to the transverse tube in an upwardly direction, i.e., away from the kite profile, and are only bent inwardly in a downwards direction into the profile structure by the inclined sail. The batten profile is then configured such as to cause the optimized, rounded range of attack to form.

The support members extend, for instance, in direction of impacting flow along the profile and support the sail so as to increase the angle of attack. I.e., in this solution the sail battens extend more or less in parallel with the transverse ribs of the tube arrangement. It is, however, quite possible for these sail battens to be inclined relative to the direction of enveloping flow so as to imbue the kite with a predetermined air flow profile.

In the solution in accordance with the invention, the front tube diameter is preferably by at least 10% smaller than in conventional solutions.

In one solution, the transverse ribs extend not along the sail (canopy) but more or less radially or straight from the front tube to the trailing edge. The actual profile is determined by the support members that define with the transverse ribs a space which may be covered by a canopy. This space then approximately corresponds to a profile cross-section of the kite.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

Further advantageous developments are subject matter of further subclaims.

### BRIEF DESCRIPTION OF THE DRAWINGS

In the following a preferred exemplary embodiment of the invention shall be explained in more detail by referring to schematic drawings, wherein:

FIG. 1 is a schematic representation of a tube kite executed as a five-line type;

FIG. 2 is a schematic representation of the kite profile in accordance with the invention;

FIG. 3 is a schematic representation of a conventional kite profile;

FIG. 4 shows a sail batten of the kite in accordance with the invention, without a sail, which is supported on a transverse tube;

FIG. 5 shows the sail batten of FIG. 4 in the inclined condition of the sail; and

FIG. 6 shows another exemplary embodiment of a kite in accordance with the invention.

### DETAILED DESCRIPTION OF THE PREFERRED EMBODIMENTS

A kite 1 comprises a tube arrangement consisting of a front tube 2 determining the leading edge of the kite 1 and ribs 4 (transverse struts) formed thereon, over which a canopy 6 is stretched out. By inflating the front tube 2 and the ribs 4, the canopy 6 is extended into a sail, and the tube kite 1 is given a wing-type transverse profile (cf. FIG. 2) (parallel with the direction of enveloping flow). At both tips 8, 10 of the tube kite I, two front lines 12, 14 and two back lines 16, 18 each attack. The two front lines 12, 14 are combined into a central tug line 20. The two back lines 16, 18 are fastened at the end portions of a bar 22. The tug line 20 extends through the bar 22 and is fastened at the surfer's trapeze belt via a chicken loop 24. Approximately in the center range of the front tube 2 a supplementary line or trim line 26 is fastened which extends through the bar 22 in parallel with the tug line 20 and is hooked in the range between chicken loop 24 and bar 22. The supplementary line 26 may be secured to the surfer through additional securing means 28. With regard to the function of the supplementary line 26, reference is made to already existing technical literature, e.g., in the periodical Kite-Boarding.de, issue May, 2004.

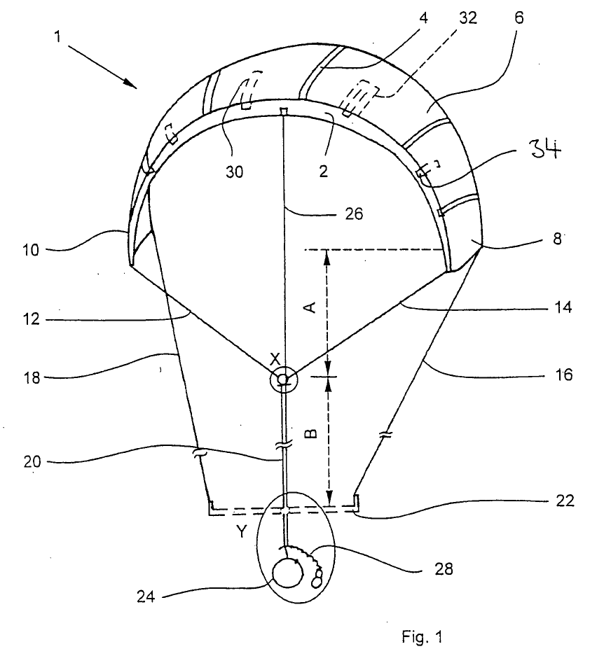

The particularity of the kite represented in FIG. 1 is that in the range of attack of the tube kite 1, a plurality of sail battens 30 are arranged which incline the canopy 6 and also the ribs (transverse struts) 4 relative to the front tube 2, so that the angle of attack α (cf. FIG. 2) is increased in comparison with conventional solutions having a front tube of identical size (FIG. 3).

With the aid of FIGS. 2 and 3 it is made clear that with use of the support members or sail battens (FIG. 2) in accordance with the invention, a substantially fuller profile is achieved in the range between the transverse tube 4 and about 20 to 30% of the maximum profile length (i.e., the distance between transverse tube and trailing edge 36), whereas this is flattened by the air flow in conventional solutions (FIG. 3), resulting in a substantially smaller angle of attack α.

The single sail battens 30 are secured by an end portion thereof to the front tube 2. This securing may, for instance, be achieved that on an outer skin of the front tube, customarily consisting of Dacron, a pocket-type reception for each sail batten 30 is formed in which the latter is inserted and optionally immobilized by bonding or sewing or other suitable connection means.

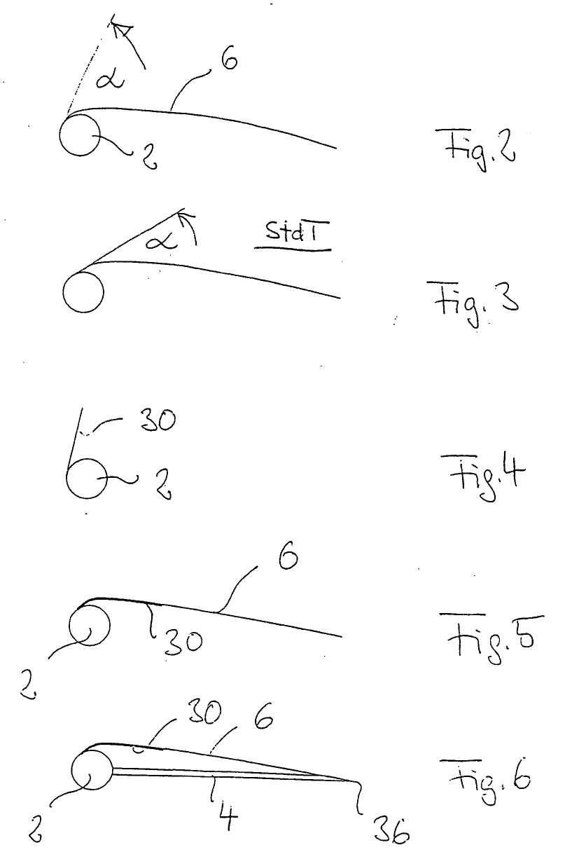

FIG. 4 shows the resulting basic position of the sail batten 30 relative to the front tube 2. The sail batten 30 extends in its installed position—without a sail—upwards in the tangential direction, i.e., away from the kite surface achieved later on by inclining the sail. By inflating the transverse tube 2 and the ribs 4 the sail is tensioned, while the sail battens 30 are bent downwardly into the plane of the sail (see FIG. 5), resulting in the air flow profile represented in FIG. 2. The sail 6 itself is customarily sewn and/or bonded with the outer skin of the front tube 2. The receptions for the sail battens 30 may be formed such that the end portions of the sail battens 30 extend beyond the securing range of the sail 6 at the front tube 2. These end portions are provided with reference symbol 34 in FIG. 1. It is also visible in accordance with the representation in FIG. 1 that the sail battens are supported on the sail 6 from below. In order to immobilize the position of the free end portions of the sail battens 30, additional sail pockets 32 may be provided on the sail 6.

In the case of a kite of the invention that is formed with support members, sail battens 30, the front tube 2 may be formed with a smaller diameter than in conventional solutions (preferably 10% smaller than conventional solutions without support members such as sail battens 30), for the arc of the kite 1 is stabilized by the full air flow profile. If a conventional kite were designed with such a small front tube diameter it would collapse.

In the exemplary embodiment represented in FIG. 1, one sail batten 30 is disposed between two respective ribs 4—it is, of course, also possible to choose different pitches where, for instance, more sail battens 30 are disposed in the central range of the kite than in the outer range, i.e., in the range of the tips. The rigidity and the length of the sail battens 30 is adapted such that the desired full air flow profile (FIGS. 2, 5) develops.

As was already mentioned, the inflatable ribs 4 or the sail battens (Booster) in the prior art are not suitable for imbuing the kite with the desired air flow profile, but have essentially the function of inclining the sail 6 and maintaining the leading edge in the desired relative position with the trailing edge 36. As a result of the known ribs 4, at best the profile in the center range, i.e., in the range between the transverse tube 2 and the trailing edge 36, is influenced (see FIG. 6).

Inasmuch as the profile shape is essentially predetermined by the sail battens 30 in the solution according to the invention, it is optionally even possible in an alternative exemplary embodiment to forego the ribs (transverse struts) 4 for profile formation of the sail. In this exemplary embodiment, the ribs 4 extend substantially directly between the front tube 2 and the trailing edge 36; the space between the sail 6 and the transverse rib 4 may optionally be covered with canopy, so that the gusset between front tube 2, sail 6, and rib 4 is covered. Such a rib 4 then only has the function of inclining the sail 6, while profile formation results solely from the sail battens 30. In this case the sail battens 30 might also be situated in the vertical plane intersecting the transverse ribs 4.

In the above described exemplary embodiment, sail battens 30 are utilized in order to provide the kite 1 with the predetermined air flow profile. It is, of course, also possible to use other support members such as plate-shaped inserts, foam bodies, etc. The conventionally inserted ribs 4 (transverse struts) are not sufficient for imbuing the kite 1 with the predetermined profile. In most cases it is sufficient if the sail battens 30 extend to one half or 30% at the most of the profile length (distance between front tube 2 and trailing edge 36). In principle the sail battens 30 may also be integrated in the inflatable transverse struts (ribs) 4.

What is disclosed is a tube kite where support members, e.g., sail battens, are formed in the range of attack in order to increase the angle of attack in comparison with conventional solutions, so that it is possible to reduce the diameter of a front tube.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept. The scope of still other changes to the described embodiments that fall within the present invention but that are not specifically discussed above will become apparent from the appended claims and other attachments.

What is claimed is:

1. A tube kite comprising a tube arrangement carrying a sail, wherein a front tube, transverse ribs and a canopy inclined relative thereto form a profile, and wherein on the front tube, between tips of the kite, support members supporting the sail are attached, whereby the sail is inclined relative to the front tube so as to increase an angle of attack, and which extend substantially only along a portion of the profile.

2. The tube kite in accordance with claim 1, wherein the support members are sail battens.

3. The tube kite in accordance with claim 1, wherein the support members are secured at receptions of an outer skin of the front tube.

4. The tube kite in accordance with claim 3, wherein the receptions extend beyond the attachment range of the sail at the front tube.

5. The tube kite in accordance with claim 1, wherein the support members, in the absence of a sail to be supported, extend approximately tangentially to the front tube and through the sail, and in the assembled condition are tensioned from the tangential position into the profile.

6. The tube kite in accordance with claim 1, wherein the support members extend along less than about half of the profile length.

7. The tube kite in accordance with claim 1, wherein the front tube diameter is reduced at least about 10% compared to tube kites without support members.

8. The tube kite in accordance with claim 1, wherein the transverse ribs extend substantially in a straight line from the front tube to a trailing edge, with the profile bulge being formed essentially by the support members.

9. The tube kite in accordance with claim 8, wherein a space between support member and transverse rib is closed by a canopy.

10. The tube kite in accordance with claim 6, wherein the support members extend along less than about 30% of the profile length
